(19) United States
(12) Patent Application Publication
(10) Pub. No.: US 2019/0058239 A1
(43) Pub. Date: Feb. 21, 2019

(54) ANTENNA MOUNTING BRACKET ASSEMBLY

(71) Applicant: CommScope Design & Integration UK Limited, Fife (GB)

(72) Inventor: Barnaby C. Smith, Dorking (GB)

(21) Appl. No.: 16/048,998

(22) Filed: Jul. 30, 2018

Related U.S. Application Data
(60) Provisional application No. 62/545,537, filed on Aug. 15, 2017.

(51) Int. Cl. H01Q 1/12; H01Q 21/00

(52) U.S. Cl. CPC H01Q 1/1242; H01Q 21/0025; H01Q 1/1228

(57) ABSTRACT

An assembly for mounting an antenna to a mounting structure, such as a street pole, is provided. The antenna assembly can include an tipper and a lower mounting bracket that can be attached to an antenna. Each mounting bracket has hooks designed to be inserted into pre-formed holes in the mounting structure. The antenna becomes secured to the mounting structure when the hooks latch into the pre-formed holes of the mounting structure.

### RELATED APPLICATION

The present application claims priority from and the benefit of U.S. Provisional Patent Application No. 62/545,537, filed Aug. 15, 2017, the disclosure of which is hereby incorporated herein in its entirety.

### FIELD OF THE INVENTION

The present invention is directed to an assembly to mount an antenna to a mounting structure.

### BACKGROUND OF THE INVENTION

Antennas for wireless communications are typically mounted on an antenna tower or other elevated mounting structure, for example a street pole. Currently, a majority of these antennas are secured to the mounting structure through use of a bolted mechanical connection. The limited space between the antennas and the mounting structure makes installation and maintenance at times difficult for a technician. Having an additional way to further secure the antennas to the mounting structure may also be beneficial from a safety perspective.

### SUMMARY

As a first aspect, embodiments of the invention are directed to an, antenna assembly. The antenna assembly comprises: an antenna; a first mounting bracket mounted to the antenna comprising a first panel and a first plurality of hooks, wherein the first plurality of hooks is configured to secure the first mounting bracket to a mounting structure; and a second mounting bracket mounted, to the antenna comprising a second panel and a second plurality of hooks, wherein the second plurality of hooks is configured to secure the second mounting bracket to the mounting structure. The first mounting bracket and the second mounting bracket are configured to secure the antenna to the mounting structure,

As a second aspect, embodiments of the invention are directed to an antenna assembly comprising: an antenna; a mounting structure; a first mounting bracket mounted to the antenna comprising a first panel and a first plurality of hooks; and a second mounting bracket mounted to the antenna comprising a second panel and a second plurality of hooks. The first and second pluralities of hooks are inserted into pre-formed holes in the mounting structure.

As a third aspect an antenna assembly comprising: three antennas; a mounting structure; a first mounting bracket mounted to each antenna, wherein each first mounting bracket comprises a first panel and a first plurality of hooks; and a second mounting bracket mounted to each antenna, wherein each second mounting bracket comprises a second panel and a second plurality of hooks. The antennas are secured to the mounting structure when the first and second pluralities of hooks of each respective antenna are inserted into pre-formed holes in the mounting structure.

### BRIEF DESCRIPTION OF THE FIGURES

FIG. 1 is a side view of an antenna assembly according to embodiments of the present invention.

FIG. 2 is a perspective view of the upper mounting bracket of the antenna assembly of FIG. 1,

FIG. 3 is a perspective view of the lower mounting bracket of the antenna assembly of FIG. 1.

FIG. 4 is a side view of the upper mounting bracket of the antenna assembly of FIG. 1.

FIG. 5 is a side view of the lower mounting bracket of the antenna assembly or FIG. 1.

FIG. 6 is a top view of upper mounting bracket of the antenna assembly of FIG. 1.

FIG. 7 is a top view of the lower mounting bracket of the antenna assembly of FIG. 1.

FIGS. 8A-D is a side view of an antenna assembly secured to a mounting bracket according, to embodiments of the present invention.

FIG. 9 is a perspective view showing three antennas using an antenna assembly according to embodiments of the present invention.

FIG. 10 is a perspective view of the antenna assembly of FIG. 9 with cables attached thereto.

FIG. 11 is a top perspective view of the antenna assembly of FIG. 9 showing attachment of the upper mounting brackets to a pole via a cap.

FIG. 12 is an enlarged partial perspective view of the antenna assembly of FIG. 9 showing attachment of the lower brackets to a pole via a band clamp.

### DETAILED DESCRIPTION OF THE INVENTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or, more of the associated listed items.

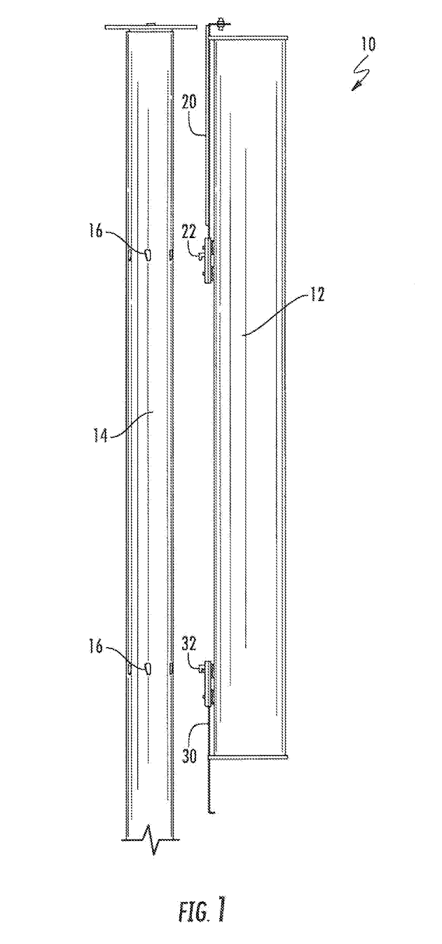

Referring now to the figures, an antenna assembly 10 for mounting an antenna 12 is illustrated in FIGS. 1-12. The antenna assembly 10 is described herein in connection with antennas attached to a street pole. This particular application is described for exemplary purposes only. The antenna assembly 10 may be used to secure other types of antennas to different types of structures.

In one embodiment of the present invention, the antenna assembly 10 comprises a first upper mounting bracket 20 and second lower mounting bracket 30 (FIG. 1). The upper and lower mounting brackets 20, 30 are mounted to an antenna 12 and are configured to secure the antenna 12 to a mounting structure 14, such as a street pole or the like.

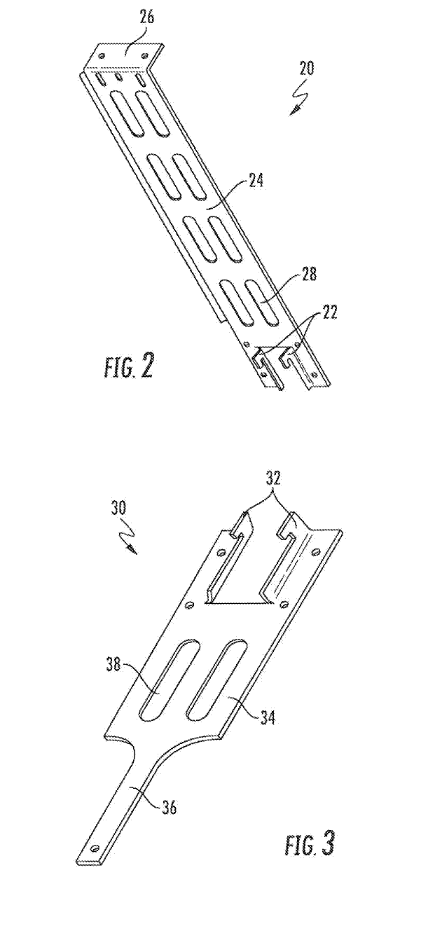

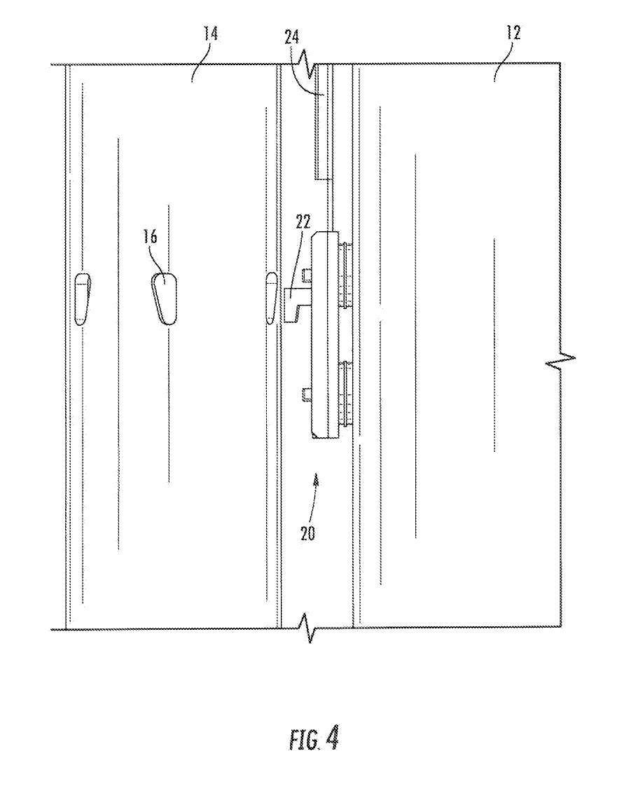

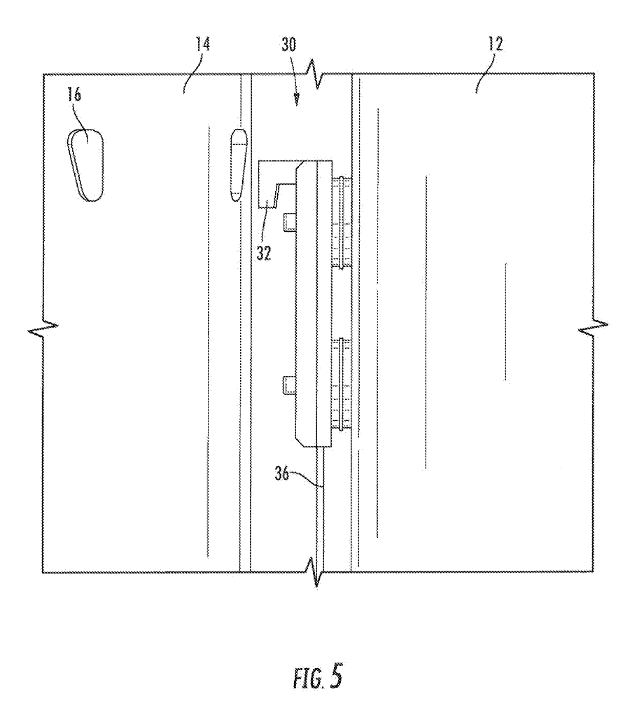

The upper mounting bracket 20 comprises a panel 24 and two hooks 22 (FIG. 2). The hooks 22 are configured to secure the upper mounting bracket 20 to the mounting structure 14 (FIG. 1). The lower mounting bracket 30 also comprises a panel 34 and two hooks 32 (FIG. 3). Like the hooks 22 of the upper mounting bracket 20, the hooks 32 are configured to secure the lower mounting bracket to the mounting structure 14 (FIG. 1). Note that the present invention is not limited to the number of hooks 22, 32 that may be, used. Any number of hooks 22, 32 may be used to secure the antenna 12 to a mounting structure 14.

In some embodiments, the panels 24, 34 may comprise holes 28, 38. The holes 28, 38 reduce the overall weight of the upper and lower mounting brackets 20, 30. Reducing the overall weight has many advantages including, but not limited to, ease of use and cost savings. These holes 28, 38 can take the form of a variety of different shapes (e.g., holes, slots) and sizes, so long as the structural integrity of the brackets 20, 30 is not affected.

In FIGS. 2 and 3, the upper and lower brackets 20, 30 are shown as separate brackets; however, the brackets 20, 30 may form a monolithic structure.

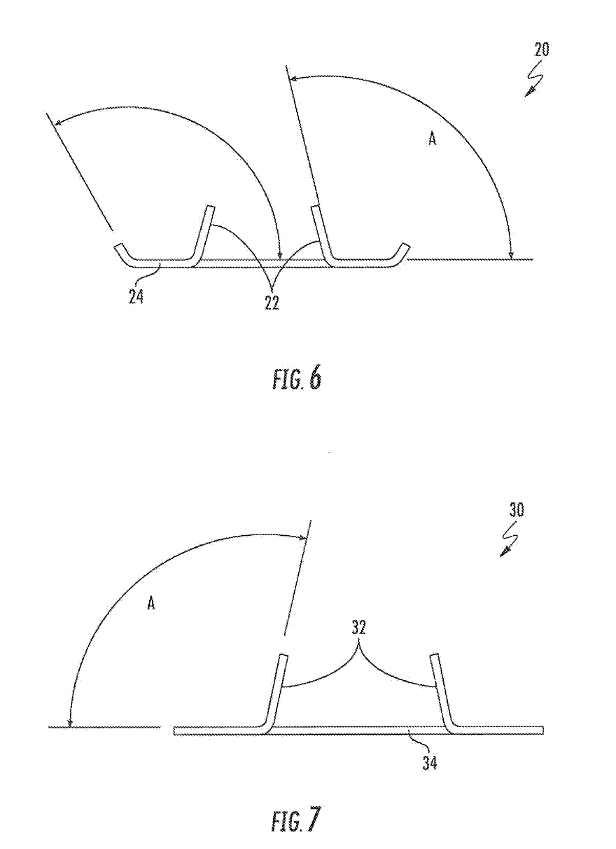

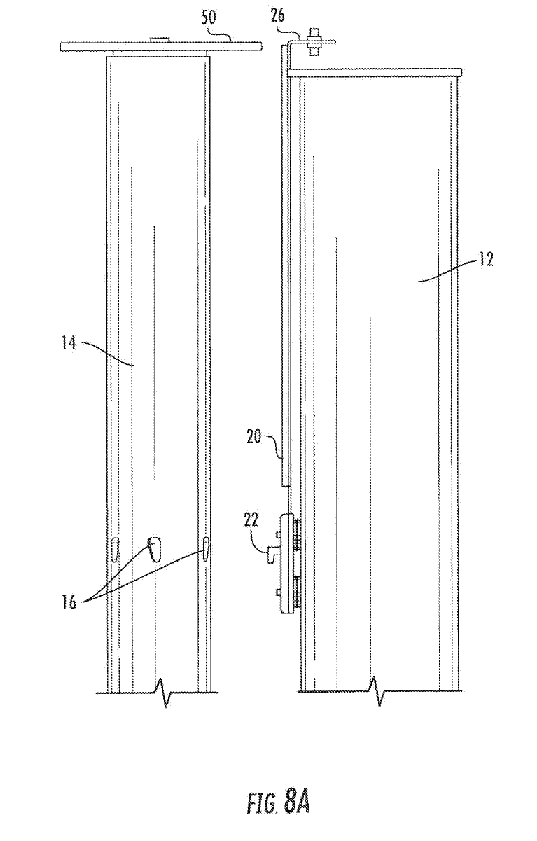

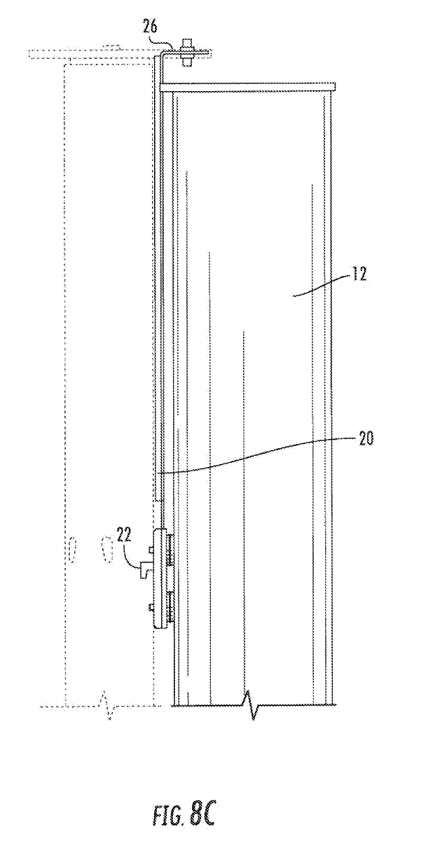

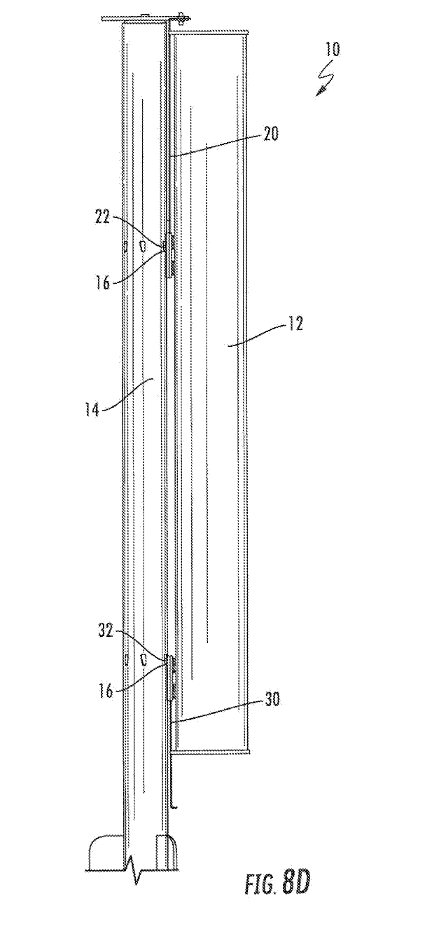

In some embodiments, the hooks 22, 32 are configured to be inserted into pre-formed holes 16 in the mounting structure 14 (FIGS. 4 and 5). Once the hooks 22, 32 are inserted into the pre-formed holes 16, the antenna 12 becomes secured to the mounting structure 14 (FIGS. 8A-D).

The hooks 22, 32 can take the form of a variety of different shapes and sizes and are not limited to the shapes and sizes as illustrated in FIGS. 2 and 3. The shape and size of the hooks 22, 32 may be dependent on the shape and size of the pre-formed holes 16 or vice versa. Alternatively, other latching mechanisms may be used.

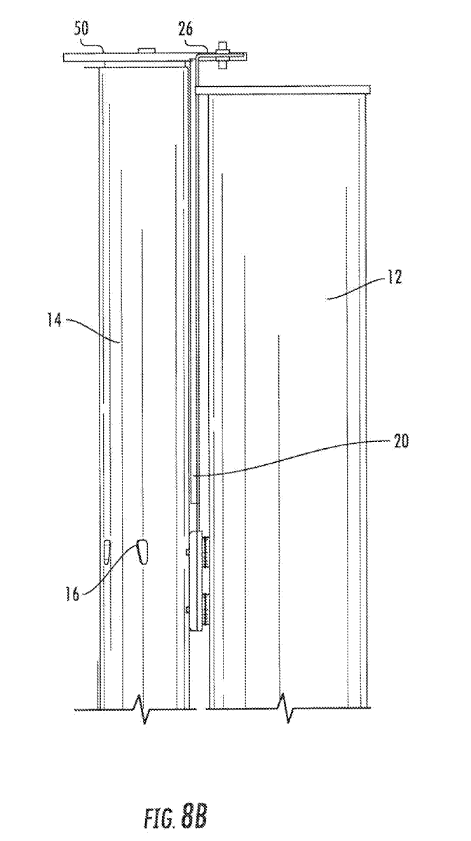

In some embodiments, each of the hooks 22 may be configured at an angle (A) greater than 90 degrees with respect to the panel 24 of the upper mounting bracket 20 (FIG. 6). The angle (A) may match the curvature of the mounting structure 14 which allows the hooks 22 to more easily latch onto the mounting structure 14 when inserted into the pre-formed holes 16, thus, improving the mounting of the antenna 12 to the mounting structure 14. In some embodiments, each of the hooks 22 may be perpendicular to the panel 24 (i.e., 90 degrees).

In some embodiments, the hooks 32 may be configured at an angle (A) greater than 90 degrees with respect to the panel 34 of the lower mounting bracket 30 (FIG. 7). Similar to the hooks 22, the angle (A) may match the curvature of the mounting structure 14 which allows the hooks 32 to more easily latch onto the mounting structure 14 when inserted into the pre-formed holes 16 improving the mounting of the antenna 12 to the mounting structure 14. In sonic embodiments, each of the hooks 32 may be perpendicular to the panel 34 (i.e., 90 degrees).

In some embodiments, the upper mounting bracket 20 further comprises a flange 26 that is perpendicular to the panel 24 (FIG. 2). The flange 26 is configured to further secure the upper mounting, bracket 20 to the mounting structure 14 in the manner discussed below (FIGS. 8A-C).

In some embodiments, the lower mounting bracket 30 further comprises an extension 36 that is parallel to the panel 34 (FIG. 3). The extension 36 is configured to further secure the lower mounting bracket 30 to the mounting structure 14 in the manner discussed below.

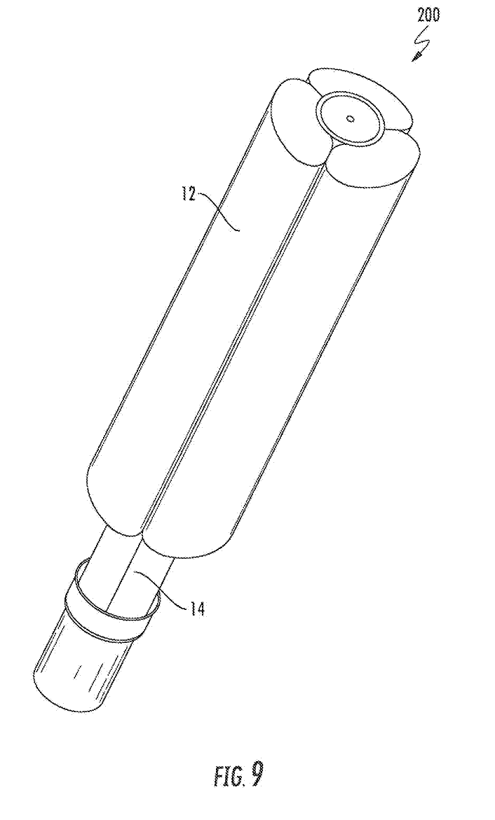

Three antenna assemblies 10 can be mounted on the mounting structure 14 to form a complete antenna system 200 with full coverage (FIG. 9). Like described above, each antenna 12 is secured to the mounting structure 14 by inserting the hooks 22, 32 into the pre-formed holes 16 in the mounting structure 14.

Additionally, if the mounting structure 14 does not have pre-formed holes 16, holes can be created in the field to accommodate the mounting brackets 20, 30 of the present invention.

As noted above, in some embodiments, the upper mounting bracket 20 of each antenna 12 further comprises a flange 26 that is perpendicular to the panel 24. Each flange 26 may be secured by a cap 50 or other securing device mounted on the top portion of the mounting structure 14 (FIGS. 8A-C and 11). This configuration helps further secure each respective antenna 12 to the mounting structure 14.

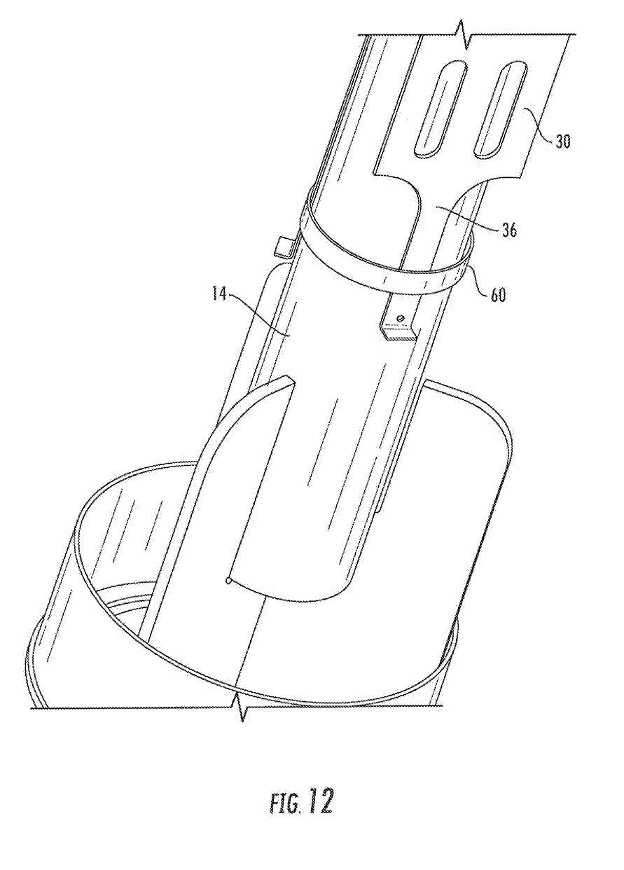

Also, as noted above, in some embodiments, the lower mounting bracket 30 of each antenna 12 further comprises an extension 36 that is parallel to the panel 34. Each extension 36 may be secured to the mounting structure 14 via a band clamp 60 (FIG. 12) or other securing device. This configuration helps further secure each respective antenna 12 to the mounting structure 14.

The dimensions of the upper and lower mounting brackets 20, 30 can vary based on the size of the antenna 12 and mounting structure 14 to which the antenna 12 is being mounted. For example, the upper mounting bracket 20 may be about 720 millimeters by about 125 millimeters. The lower mounting bracket 30, for example, may be about 410 millimeters (including extension 26) by about 125 millimeters. The hooks 22, 32 may extend about 28 millimeters from the panels 24, 34. For brackets 20, 30 comprising two hooks 22. 32, the hooks 22, 32 may be about 70 millimeters apart from each other. The spacing of the hooks 22, 32 can vary based on the dimensions (e.g., diameter) of the mounting structure 14. The typical diameter of the mounting structure 14 may be about 127 millimeters.

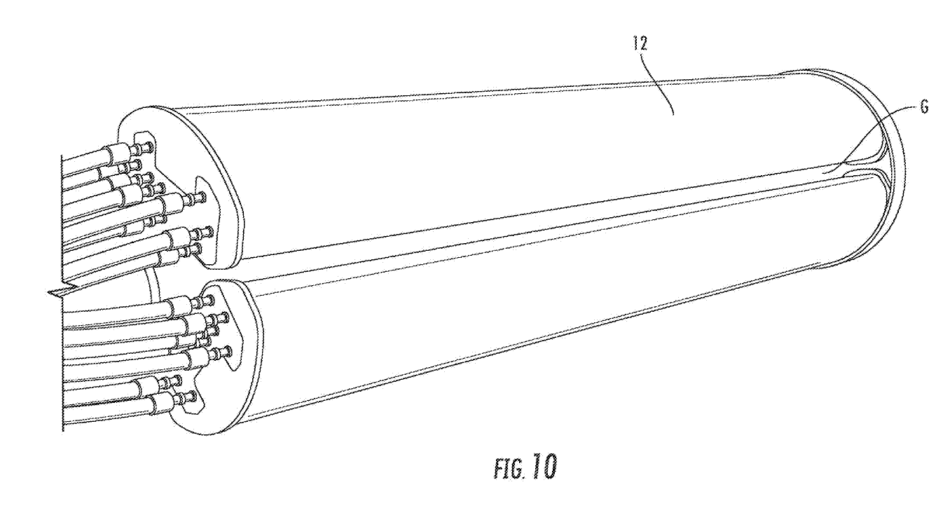

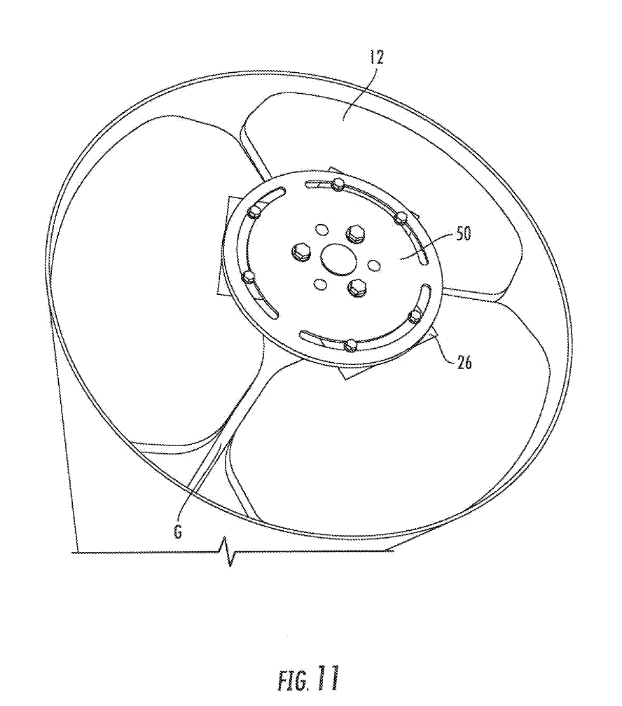

In some embodiments, when each of the three antennas 12 is secured to the mounting structure 14, the side edge of each antenna may be immediately adjacent to a side edge of an adjacent antenna 12 (FIGS. 10 and 11). In some embodiments, between the side edges of each antenna 12 is a small gap (G). The gap (G) may be between about 0 millimeters and about 20 millimeters. The gap (G) can vary based on the type of antenna 12 being used. Because of the limited space between the antennas 12, use of the upper and lower mounting brackets 20, 30 may significantly facilitate mounting of the antennas 12.

The antenna assemblies of the present invention can be formed from a variety of materials that can withstand a wide range of environmental conditions, but the mounting brackets must be comprised from a material that is able to at least support the weight of the antenna(s). In some embodiments, the antenna assemblies may be formed from galvanized steel, stainless steel, or the like.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An antenna assembly, comprising:
an antenna;
a first mounting bracket mounted to the antenna comprising a first panel and a first plurality of hooks, wherein the first plurality of hooks is configured to secure the first mounting bracket to a mounting structure; and
a second mounting bracket mounted to the antenna comprising a second panel and a second plurality of hooks, wherein the second plurality of hooks is configured to secure the second mounting bracket to the mounting structure.
wherein the first mounting bracket and the second mounting bracket are configured to secure the antenna to the mounting structure.

2. The antenna assembly of claim 1, wherein the first plurality of hooks are configured at an angle greater than 90 degrees with respect to the first panel of the first, mounting bracket.

3. The antenna assembly of claim 1, wherein the second plurality of hooks are configured at an angle greater than 90 degrees with respect to the second panel of the second mounting bracket,

4. The antenna assembly of claim 1, wherein the first mounting bracket further comprises a flange perpendicular to the first panel configured to further secure the first mounting bracket.

5. The antenna assembly of claim 1, wherein the second mounting bracket further comprises an extension parallel to the second panel configured to further secure the second mounting bracket.

6. The antenna assembly of claim 1, wherein the first and second pluralities of hooks are configured to insert into pre-formed holes in the mounting structure to secure the antenna to the mounting structure.

7. The antenna assembly of claim 1, wherein the antenna assembly, comprises galvanized or stainless steel.

8. The antenna assembly of claim 1, wherein the first and second mounting brackets comprise holes.

9. An antenna assembly, comprising;
an antenna;
a mounting structure;
a first mounting bracket mounted to the antenna comprising a first panel and a first plurality of hooks; and
a second mounting bracket mounted to the antenna comprising a second panel and a second plurality of hooks,
wherein the first and second pluralities of hooks are inserted, into pre-formed holes in the mounting structure.

10. The antenna assembly of claim 9, wherein the first plurality of hooks are configured at an angle greater than 90 degrees with respect to the first panel of the first mounting bracket.

11. The antenna assembly of claim 9, wherein the second plurality of hooks are configured at an angle greater than 90 degrees with respect to the second panel of the second mounting bracket.

12. The antenna assembly of claim 9, wherein the first mounting bracket farther comprises a flange perpendicular to the first panel secured the first mounting bracket.

13. The antenna assembly of claim 9, wherein the second mounting bracket further comprises an extension parallel to the second panel configured to further secure the second mounting bracket.

14. The antenna assembly of claim 9, wherein the first and second pluralities of hooks are configured to insert into pre-formed holes in the mounting structure to secure the antenna to the mounting structure.

15. The antenna assembly of claim 9, wherein the antenna assembly comprises galvanized or stainless steel.

16. An antenna assembly, comprising:
three antennas;
a mounting structure;
a first mounting bracket mounted to each antenna, wherein each first mounting bracket comprises a first panel and a first plurality of hooks; and
a second mounting bracket mounted to each antenna, wherein each second mounting bracket comprises a second panel and a second plurality of hooks,
wherein the antennas are secured to the mounting structure when the first and second pluralities of hooks of each respective antenna are inserted into pre-formed holes in the mounting structure.

17. The antenna assembly of claim 16, wherein a side edge of each antenna is immediately adjacent a side edge of an adjacent antenna.

18. The antenna assembly of claim 17, wherein a gap between about 0 millimeters and about 20 millimeters is located between the side edge of each antenna.

19. The antenna assembly of claim 16, wherein the first plurality of hooks are configured at an angle greater than 90 degrees with respect to the first panel of the first, mounting bracket.

20. The antenna assembly of claim 16, wherein the second plurality of hooks are configured at an angle greater than 90 degrees with respect to the second panel of the second mounting bracket.
